(19) United States
(12) Patent Application Publication
(10) Pub. No.: US 2020/0259332 A1
(43) Pub. Date: Aug. 13, 2020

(54) LOAD SWITCH FOR FRAGILE ELECTRIC POWER NETWORKS

(71) Applicant: S&C Electric Company, Chicago, IL (US)

(72) Inventors: Martin T Bishop, Oak Creek, WI (US); Stephen E Williams, Caledonia, WI (US)

(73) Assignee: S&C Electric Company, Chicago, IL (US)

(21) Appl. No.: 16/740,783

(22) Filed: Jan. 13, 2020

Related U.S. Application Data
(60) Provisional application No. 62/804,865, filed on Feb. 13, 2019.

(51) Int. Cl. H02J 3/38; H02J 9/06

(52) U.S. Cl. CPC H02J 3/38; H02J 9/06

(57) ABSTRACT

A system and method for selectively connecting loads in a power system network, where the loads are coupled to a number of lateral lines and the lateral lines are coupled to a feeder line, when the feeder line is disconnected from an electrical grid as a result of voltage outside of a predetermined range. Each lateral line includes a switching device positioned where the lateral line connects to the feeder line, where each switching device is provided with a timing control to switch on or off the switching device with a delay time. When the network is disconnected from the electrical grid, the switching devices detect the voltage being outside of the predetermined range and then open. When power sources in the network are returned to service the network, the switching devices detect that voltage is within the predetermined range and are closed based on a certain predetermined delay.

### CROSS-REFERENCE TO RELATED APPLICATION

This application claims the benefit of priority from the U.S. Provisional Application No. 62/804,865, filed on Feb. 13, 2019, the disclosure of which is hereby expressly incorporated herein by reference for all purposes.

### BACKGROUND

### Field

This disclosure relates generally to a system and method for selectively connecting or disconnecting loads in a fragile power system network, such as a micro-grid.

### Discussion

An electrical power distribution network, often referred to as an electrical grid, typically includes a number of power generation plants each having a number of power generators, such as gas turbines, nuclear reactors, coal-fired generators, hydro-electric dams, etc. The power plants provide power at a variety of medium voltages that are then stepped up by transformers to a high voltage AC signal to be connected to high voltage transmission lines that deliver electrical power to a number of substations typically located within a community, where the voltage is stepped down to a medium voltage for distribution. The substations provide the medium voltage power to a number of three-phase feeder lines. The feeder lines are coupled to a number of lateral lines that provide the medium voltage to various distribution transformers, where the voltage is stepped down to a low voltage and is provided to a number of loads, such as homes, businesses, etc.

Some electrical grids may include one or more micro-grids, where each micro-grid includes one or more power sources, such as photovoltaic cells, generators, battery modules, wind turbines, etc., and where the power sources may be distributed throughout the micro-grid. The power sources in the micro-grid may be generating power during normal operation when the micro-grid is connected to the electrical grid, where the micro-grid power sources may be reducing the amount of power that the loads in the micro-grid are drawing from the electrical grid or may be placing power onto the electrical grid.

When a micro-grid is disconnected from the electrical grid as a result of power loss from a fault in the utility grid or otherwise, circuit breakers in the micro-grid are opened at the interconnection point of the micro-grid and the main utility grid prior to the micro-grid power sources being switched on to allow the power sources to start. Once the power sources are providing electrical energy, then the circuit breakers or other switching devices are closed in a certain sequence to add load to the sources. This operation typically occurs very quickly where significant load is coupled to the power sources in a relatively short amount of time. The power sources in a micro-grid are often low-inertia power sources, such as combustion based rotating generators, that only generate a small amount of power relative to the power providing capability of the utility grid. The low inertia is a consequence of a relatively small rotating mass in the generator or generators, where coupling or decoupling of loads in the micro-grid has an effect on the frequency of the system voltage. Thus, when a large load is coupled to the generator, the rotating speed of the generator significantly decreases. In other words, when the kinetic energy of the rotating mass in the generator is converted to electrical energy to meet the power demand, the rotational speed of the rotating mass decreases, causing the reduction in electrical system frequency. Thus, the mechanical power input to the generator needs time to ramp up to meet the increased electrical demand output of the generator in order to restore system frequency. Hence, the frequency will decrease until the generator prime mover increases its active power output to match the load and recover when the generator prime mover output exceeds the load as the governor and voltage regulators bring the generation output (watts and vars) back in balance with the load. The same phenomenon occurs when load is removed from the generator in that the reduced conversion of mechanical energy to electrical energy causes the rotating generator to speed up and increase the frequency. These types of frequency and voltage deviations can limit the generator's ability to accept or reject loads and cause power quality issues at the loads that are undesirable.

It is possible for the utility controlling the electrical grid to provide switches and other devices at various locations throughout the electrical grid and the micro-grid and provide the necessary communications therebetween to control how loads are being added and removed from the grid based on some predetermined priority so as to prevent the type of frequency and voltage changes of the power sources described. Further, the power sources employed in the micro-grid could be made larger to more easily support larger load changes. It is also possible to provide an energy storage system, such as a battery bank, that can be discharged when large loads are added to the grid to provide the additional power necessary to meet the demand without adversely affecting the power source. However, because of the necessary controls, communications, hardware, etc. these are expensive solutions, and a lower cost solution is desired.

### SUMMARY

The present disclosure describes a system and method for selectively connecting loads in a fragile power system network, such as a micro-grid, in a predetermined autonomous manner, using only locally measured quantities having no interaction with any remotely located control system devices, where the loads are coupled to a number of lateral lines and the lateral lines are coupled to a feeder line, when the feeder line is disconnected from an electrical grid as a result of a power loss in the electrical grid, or at other times when the feeder line is connected to the electrical grid when low short circuit level and/or low inertia conditions occur. Each lateral line includes a switching device positioned where the lateral line connects to the feeder line, where each switching device is provided with a timing control to switch on or off the switching device after a certain delay timer expires. As an example, when the power system network is disconnected from the electrical grid, the switching devices detect the voltage is not within a predetermined range and then open. Power sources in the power system network are then turned on. The switching devices detect that system voltage is within the predetermined range indicating that power is now available and are closed based on a predetermined delay. The delay can be randomly selected according to a predetermined statistical distribution or can be based on a priority of the loads. If the utility grid is operating in the low short circuit and/or low inertia condition with multiple sources of electrical power disabled, it may be desirable to restore power to the loads in smaller increments in order to minimize voltage and frequency disturbances to customers that are already on line.

Additional features of the present disclosure will become apparent from the following description and appended claims, taken in conjunction with the accompanying drawings.

### BRIEF DESCRIPTION OF THE DRAWINGS

FIG. 1 is a block diagram of an electrical power distribution network including a distribution feeder that may be configured as a micro-grid connected to a utility grid, where the micro-grid includes a number of lateral lines connected to a feeder line through a switching device; and

FIG. 2 is an isometric view of a recloser having a vacuum interrupter switch that can be used as the switching devices in the micro-grid shown in FIG. 1.

### DETAILED DESCRIPTION OF THE EMBODIMENTS

The following discussion of the embodiments of the disclosure directed to a system and method for selectively connecting loads in a distribution feeder or a micro-grid in a predetermined autonomous manner, where the loads are coupled to a number of lateral lines and the lateral lines are coupled to a feeder line, when the feeder line is disconnected from an electrical grid as a result of a power loss in the electrical grid is merely exemplary in nature, and is in no way intended to limit the disclosure or its applications or uses.

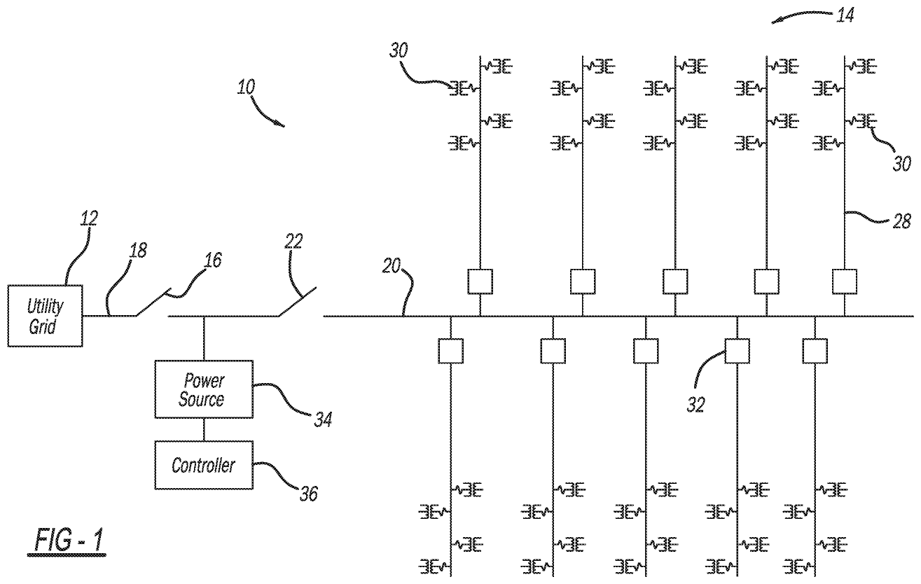

FIG. 1 is a block diagram of an electrical power distribution network 10 that includes a utility grid 12 electrically coupled to a fragile power system network, referred to herein as a micro-grid 14, by an electrical line 18 through a micro-grid disconnect switch 16 operating as a point of common coupling (PCC) therebetween. The network 10 is intended to represent any electrical power distribution system or network of any size and configuration that provides electrical power from any number or type of power sources (not shown) over any suitable distance on any type of transmission line (not shown) to electrical substations (not shown) to be distributed on feeder lines (not shown) to any suitable load. Further, the micro-grid 14 discussed herein is intended to represent any fragile power network system, such as a low inertia system, a weak source system, a weak grid, a low available short circuit current system, a high source impedance system, etc., or portion of an electrical grid that can be disconnected therefrom and be powered by its own power sources.

A feeder line 20 is connected to the electrical line 18 on the micro-grid side of the switch 16 in the micro-grid 14, where the feeder line 20 includes a power source disconnect switch 22, and where the feeder line 20 is typically a three-phase line. A number of lateral lines 28 are coupled to the feeder line 20, where each lateral line 28 can be a single-phase line, a two-phase line or a three-phase line. A number of loads 30 are coupled to each of the lateral lines 28 and can be any suitable load, such as a home, a building, a business, etc. A switch 32, discussed in detail below, is provided in each lateral line 28 and is operable to connect or disconnect the lateral line 28, and all of the loads 30 coupled thereto, from the feeder line 20 under a certain control scheme as discussed herein. A power source 34, such as photovoltaic cells, generators, battery modules, wind turbines, etc., is connected to the feeder line 20 and is intended to represent one or all of the power sources in the micro-grid 14, where the power sources 34 may be distributed throughout the micro-grid 14, that can power the micro-grid 14 and put excess power onto the utility grid 12 when the micro-grid connection switch 16 is closed. A controller 36 includes the necessary hardware, such as grid forming devices, ground source devices, balancing devices, etc., and software for controlling the power source 34.

The present disclosure proposes an autonomous control scheme for selectively opening and closing the switches 32 in response to the voltage applied at the switch location, such as the micro-grid 14 being disconnected from the utility grid 12, where power is provided to the micro-grid 14 by the power source 34, and being connected to the utility grid 12, where power is provided to the micro-grid 14 by the utility grid 12.

During normal operation, the switches 16, 22 and 32 are all closed, the power source 34 is off and the loads 30 are being powered by the utility grid 12. In response to a fault, or otherwise, in the utility grid 12, where power is not being provided to the micro-grid 14, the switches 16 and 22 are opened to disconnect the micro-grid 14 from the utility grid 12 and disconnect the loads 30 from the power source 34. The switches 32 detect the loss of voltage, such as a reduction in voltage below a predetermined threshold, and automatically open in response thereto. The power source 34 is then started. Once voltage is restored indicating that power is available from the power source 34, the switch 22 is closed. Each switch 32 detects that voltage has now returned, such as a rise in voltage above the predetermined threshold, and then closes based on a predetermined time delay so that power is provided to the lateral lines 28 from the power source 34 in a sequential manner, and thus not all at once. Thus, the power being drawn from the source 34 during this start-up sequence is provided in small segments and is ramped up to a maximum power draw. This prevents a large power draw on the power source 34, and thus allows the power source 34 to meet the power demand without significant frequency or voltage changes. The timing control of the switches 32 can be configured so that they are switched on in a random delayed manner according to a predetermined statistical distribution or high priority loads, such as police, hospital, etc., can be turned on first using predetermined time delays configured into the switches 32.

The switches 32 can be any switch suitable for the purposes discussed herein. One suitable example includes modifying a known single phase recloser including a vacuum interrupter switch so that it is able to detect the presence or absence of voltage, and a delaying opening and closing based on an assigned delay time in response thereto.

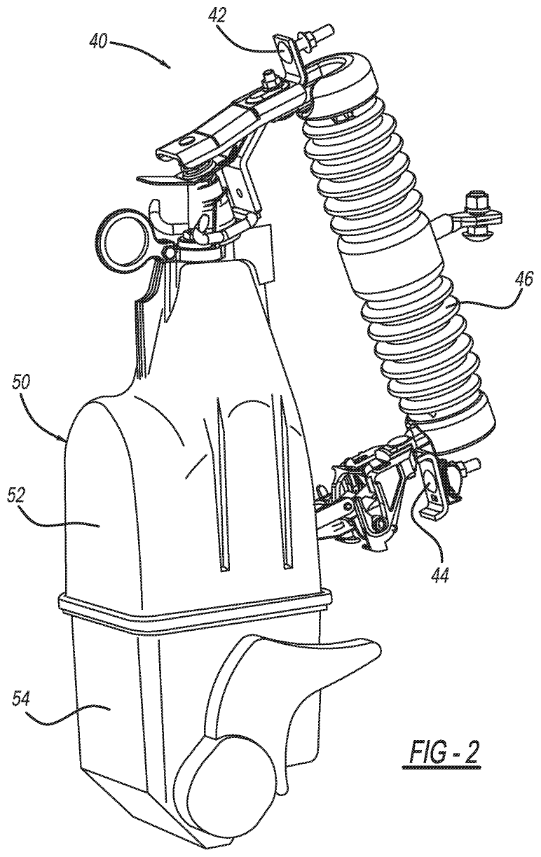

FIG. 2 is an isometric view of a recloser 40 of this type that has application for connecting and disconnecting a power line (not shown) at a number of locations in a medium power distribution network, such as on a utility pole, where the recloser 40 has been modified as described. The recloser 40 includes a mounting structure with an upper contact 42 that is connected to the source side power line, a lower contact 44 that is connected to the load side power line and an insulator 46 therebetween. The recloser 40 also includes a vacuum interrupter 50 also connected to the contacts 42 and 44, where the vacuum interrupter 50 is used as a vacuum switch (not shown) enclosed within an upper housing 52, where the vacuum switch is opened and closed to allow or prevent current flow therethrough on the power line in a well understood manner. The recloser 40 would also include a sensor (not shown) for measuring the current and voltage of the power propagating on the power line, and a controller (not shown) for processing the measurement signals and controlling the open or close status of the switch.

In order for electrical power to be generated and delivered to the loads 30 in a stable, reliable and cost-effective manner, it is necessary that the frequency of the AC signal be maintained as close as possible to a desired frequency. Therefore, power systems employ various control schemes so that the frequency of the AC signal provided on the grid 12 is maintained at the desired frequency. Generally, systems increase or decrease power generation as needed as load is added to and removed from the grid 12. However, some electrical power distribution networks are limited in their ability to respond quickly enough to an event that results in an under-frequency condition, such as a loss of a major generator or an abrupt increase in loads being applied to the grid 12. For example, certain power distribution networks, such as island grids, have a limited number of power plants that provide the power, and thus the system has a reduced ability to respond to changes in the frequency of the AC signal as needed. With an increase in distributed generation that is not controlled by the utility, or if the generation has low or zero inertia, the ability to control frequency is reduced further.

For those infrequent under-frequency transient events when the frequency of the AC signal on the electrical grid decays beyond the ability of the system to control it, the system must immediately reduce the load on the grid 12 within milliseconds so as to avoid potential system failure, referred to in the art as under-frequency load shedding. However, known under-frequency and under-voltage load shedding schemes typically shed large blocks of loads, such as a block serviced by a single substation, and do not provide any discrimination for higher priority loads.

According to another embodiment, the switches 32 can be configured to detect an under-frequency or under-voltage event at their location and then be selectively opened in a certain sequence to remove the loads 30 on the particular lateral line 28 so that lower priority loads are shed first, and higher priority loads 30 are removed last if system conditions require more load removal.

The discussion above talks about selectively turning on the loads 30 in the micro-grid 14 because the power that is able to be provided by the power source 34 may not be enough to allow energization of the loads 30 at the same time. However, this general control scheme can be used through the utility grid 12 during a black start where the entire grid 12 is in the process of recovering from an out of service condition. Specifically, the switches 32 can also be strategically provided throughout the grid 12 so that during a black start when bringing the grid 12 back on line, separate portions of the grid 12 can be started before other portions of the grid 12 so as to bring the grid 12 back on line more slowly to prevent overloading of the sources providing energy to the grid 12.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A method for controlling power flow in a fragile power system network, the power system network being electrically connected to a utility grid through a power system network disconnect switch, the power system network including a feeder line electrically coupled to the power system network disconnect switch, at least one power source electrically coupled to the feeder line, a plurality of lateral lines electrically coupled to the feeder line, a plurality of loads electrically coupled to the lateral lines, and a switching device in each lateral line that controls whether power is provided to the loads on the lateral line using only locally measured quantities having no interaction with any remotely located control system devices, the method comprising:
determining in each switching device that voltage from the utility grid is outside of a predetermined range;
opening each switching device in response to detecting that the voltage at the switching device is outside of the predetermined range;
detecting in each switching device that voltage has returned to be within the predetermined range; and
selectively closing the switching devices in a predetermined manner so that the loads on the lateral lines receive nominal voltage in a sequential manner.

2. The method according to claim 1 wherein selectively closing the switching devices includes closing the switching devices for the lateral lines having higher priority loads before closing the switching devices for the lateral lines having lower priority loads.

3. The method according to claim 1 wherein selectively closing the switching devices includes closing the switching devices in a random delayed manner according to a predetermined statistical distribution.

4. The method according to claim 1 wherein the switching devices are reclosers.

5. The method according to claim 1 wherein the switching devices detect frequency below a predetermined level and/or voltage below a predetermined level at their location and are selectively opened to disconnect the loads in a predetermined manner on the lateral lines.

6. The method according to claim 5 wherein the switching devices detect frequency above the predetermined level and/or voltage above the predetermined level at their location and are selectively closed to connect the loads in a predetermined manner on the lateral lines when service to the feeder line is restored.

7. The method according to claim 6 wherein the predetermined manner is based on a priority of the loads.

8. The method according to claim 1 wherein the feeder line is a three-phase line and the lateral lines are single phase lines.

9. The method according to claim 1 wherein the power system network is a micro-grid.

10. A method for controlling power flow in an electrical grid, the method comprising:
providing voltage on a feeder line to a plurality of lateral lines that provide voltage to a plurality of loads on each lateral line;
detecting in a switching device provided in each lateral line that voltage from the feeder line has been reduced below a predetermined threshold;
opening each switching device when voltage from the feeder line has been reduced below the predetermined threshold;
detecting in each switching device that voltage to the feeder line has increased above the predetermined threshold; and
selectively closing the switching devices in a predetermined manner so that the loads on each lateral line receive voltage in a sequential manner.

11. The method according to claim 10 wherein selectively closing the switching devices includes closing the switching devices for the lateral lines having higher priority loads before closing the switching devices for the lateral lines having lower priority loads.

12. The method according to claim 10 wherein selectively closing the switching devices includes closing the switching devices in a random delayed manner according to a predetermined statistical distribution.

13. The method according to claim 10 wherein the electrical grid is a micro-grid and the feeder line receives power from a utility grid.

14. The method according to claim 10 wherein the switching devices detect frequency below a predetermined level and/or voltage below a predetermined level at their location and are selectively opened to disconnect the loads in a predetermined manner on the lateral lines.

15. The method according to claim 14 wherein the predetermined manner is based on a priority of the loads.

16. The method according to claim 10 wherein the electrical grid is a utility grid and wherein selectively closing the switching devices in a predetermined manner includes selectively closing the switching devices during a black start defined as restarting a power system when all parts of the system are not energized.

17. The method according to claim 10 wherein the feeder line is a three-phase line and the lateral lines are single phase lines.

18. A method for controlling power flow in a power system network, the method comprising:
providing voltage on a feeder line from a utility grid to a plurality of lateral lines that provide voltage to a plurality of loads on each lateral line;
detecting in a switching device provided in each lateral line that voltage from the feeder line has been reduced below a predetermined threshold;
opening each switching device when the voltage from the feeder line has been reduced below the predetermined threshold;
detecting in each switching device that voltage is above the predetermined threshold; and
selectively closing the switching devices in a random manner according to a predetermined statistical distribution so that the loads on each lateral line receive voltage in a sequential manner.

19. The method according to claim 18 wherein the switching devices detect frequency below a predetermined level and/or voltage below a predetermined level at their location and are selectively opened to disconnect the loads in a predetermined manner on the lateral lines.

20. The method according to claim 19 wherein the switching devices detect frequency above a predetermined level and/or voltage above a predetermined level at their location and are selectively closed to connect the loads in a predetermined manner on the lateral lines when service to the feeder line is restored.
